(19) United States
(12) Patent Application Publication
(10) Pub. No.: US 2005/0289213 A1
(43) Pub. Date: Dec. 29, 2005

(54) Switching between blocking and non-blocking input/output

(75) Inventors: William T. Newport, Rochester, MN (US); James Lee Van Oosten, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/877,237

(22) Filed: Jun. 25, 2004

(51) Int. Cl. G06F 9/46

(52) U.S. Cl. 709/200; 718/100

(57) ABSTRACT

A method, apparatus, system, and signal-bearing medium that in an embodiment switch between blocking I/O and non-blocking I/O based on the number of concurrent connections. If the number of concurrent connections is greater than a high threshold, then blocking I/O is switched to non-blocking I/O. If the number of concurrent connections is less than a low threshold, then non-blocking I/O is switched to blocking I/O. In this way, I/O may be optimized depending on the number of concurrent connections, which increases performance.

### FIELD

An embodiment of the invention generally relates to computers. In particular, an embodiment of the invention generally relates to optimizing for both blocking and non-blocking input/output.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware (such as semiconductors, integrated circuits, programmable logic devices, programmable gate arrays, and circuit boards) and software, also known as computer programs.

Years ago, computers were isolated devices that did not communicate with each other. But, today computers are often connected in networks, such as the Internet or World Wide Web, and a user at one computer, often called a client, may wish to access information at multiple other computers, often called servers, via a network. Accessing and using information from multiple computers is often called distributed computing.

One of the challenges of distributed computing is handling input/output (I/O) transmissions across communications channels. A channel represents an open connection to an entity, such as a hardware device, a file, a network socket, or a program component that is capable of performing one or more distinct I/O operations, such as reading or writing data. Data transfers to communications channels can be implemented using either blocking or non-blocking I/O. In blocking I/O, also called synchronous I/O, each communications connection is assigned its own programming thread. A programming thread (a process or a part of a process) is a programming unit that is scheduled for execution on a processor and to which resources such as execution time, locks, and queues may be assigned. Blocking I/O typically has faster response times and works well for smaller numbers of concurrently open connections than does non-blocking I/O.

In non-blocking I/O, also called asynchronous I/O, all communications connections share the same programming thread or the same set of threads. Non-blocking I/O does not perform as well as blocking I/O for small numbers of concurrent connections, but non-blocking I/O does have the advantage that it scales well to large numbers of concurrent connections because non-blocking I/O does not associate a thread with each concurrent connection. Instead, in non-blocking I/O, the available thread(s) are shared between the concurrent connections, which reduces overhead since each additional thread has an associated overhead. Thus, non-blocking I/O scales to much larger numbers of concurrent connections, but trades off response time to gain this scalability.

Current techniques provide two implementations: both blocking I/O and non-blocking I/O, which require two APIs (application programming interfaces) and two programming models. This means duplicate code, one supporting blocking I/O and another providing non-blocking I/O support. It also means that middleware can only handle one type of load efficiently, either fewer concurrent connections with optimal response time or more concurrent channels trading off response time. This forces a system administrator to guess which load is likely to occur and to configure either blocking I/O or non-block I/O based on that guess, which may be incorrect, leading to poor performance.

Without a better way to handle a variety of I/O loads, distributed computing will continue to have difficulty handling a variety of numbers of concurrent connections, leading to poor performance.

### SUMMARY

A method, apparatus, system, and signal-bearing medium are provided that in an embodiment switch between blocking I/O and non-blocking I/O based on the number of concurrent connections. If the number of concurrent connections is greater than a high threshold, then blocking I/O is switched to non-blocking I/O. If the number of concurrent connections is less than a low threshold, then non-blocking I/O is switched to blocking I/O. In this way, I/O may be optimized depending on the number of concurrent connections, which increases performance.

### BRIEF DESCRIPTION OF THE DRAWING

FIG. 1 depicts a block diagram of an example system for implementing an embodiment of the invention.

FIG. 2 depicts a flowchart of example processing for handling a request for a new connection by an I/O (Input/Output) manager, according to an embodiment of the invention.

FIG. 3 depicts a flowchart of example processing for handling a request to close a connection by the I/O manager, according to an embodiment of the invention.

FIG. 4 depicts a flowchart of example processing for handling an I/O request by the I/O manager, according to an embodiment of the invention.

### DETAILED DESCRIPTION

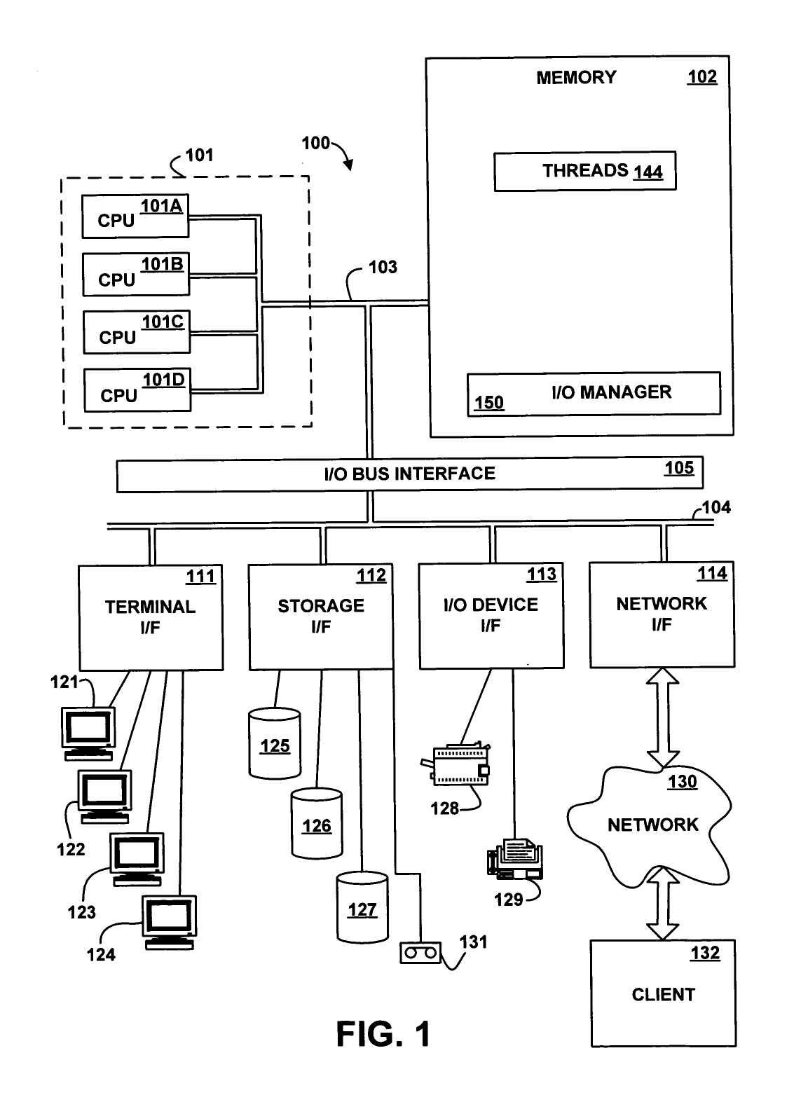

Referring to the Drawing, wherein like numbers denote like parts throughout the several views, FIG. 1 depicts a high-level block diagram representation of a computer system 100 connected to a client 132 via a network 130, according to an embodiment of the present invention. The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 includes threads 144 and an I/O manager 150. Although the threads 144 and the I/O manager 150 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the threads 144 and the I/O manager 150 are illustrated as residing in the memory 102, these elements are not necessarily all completely contained in the same storage device at the same time.

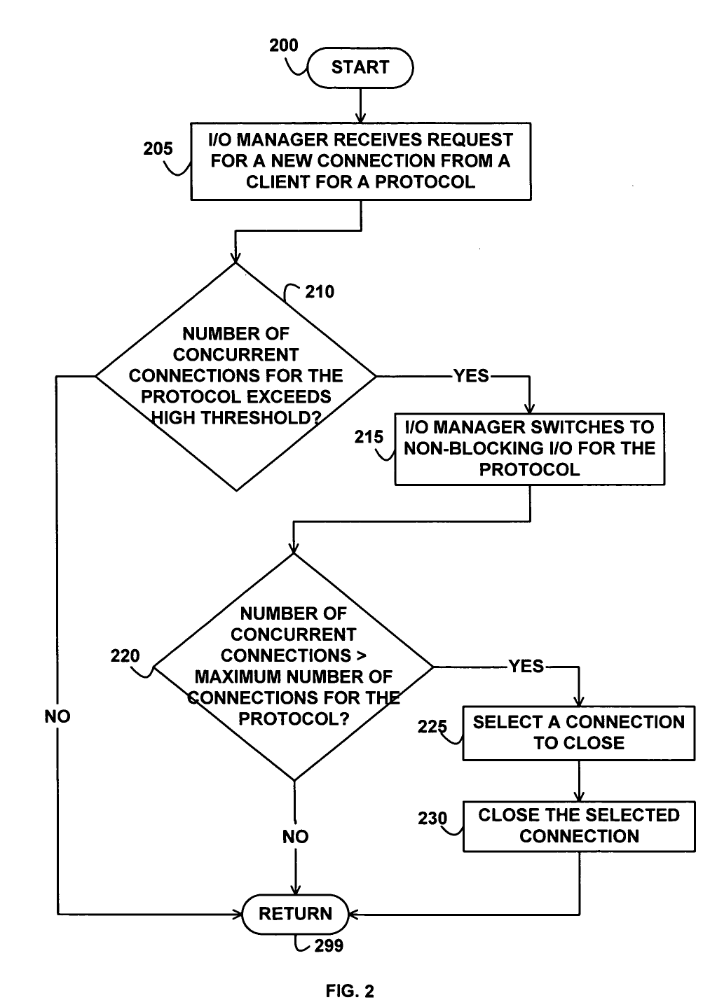

The I/O manager 150 receives and processes requests from the clients 132 to open and close connections and perform I/O requests, such as reads and writes of data to/from the clients 132. The I/O manager 150 further allocates the connections and data transfer requests among the threads 144, using either blocking I/O or non-blocking I/O. The threads 144 execute on the processor 101 to perform the data transfers. In an embodiment, the I/O manager 150 includes instructions capable of executing on the processor 101 or statements capable of being interpreted by instructions executing on the processor 101 to perform the functions as further described below with reference to FIGS. 2, 3, and 4. In another embodiment, the I/O manager 150 may be implemented in microcode. In yet another embodiment, the I/O manager 150 may be implemented in hardware via logic gates and/or other appropriate hardware techniques, in lieu of or in addition to a processor-based system.

The memory bus 103 provides a data communication path for transferring data among the processors 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interconnect) bus, or any other appropriate bus technology. The I/O interface units support communication with a variety of storage and I/O devices. For example, the terminal interface unit 111 supports the attachment of one or more user terminals 121, 122, 123, and 124.

The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the DASD 125, 126, and 127 may be loaded from and stored to the memory 102 as needed. The storage interface unit 112 may also support other types of devices, such as a tape device 131, an optical device, or any other type of storage device.

The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The client 132 requests the I/O manager 150 to open and close connections to the computer system 100 and sends I/O requests to I/O manager 150. The client 132 may include some or all of the hardware components previously described above for the computer system 100. Although only one client 132 is illustrated, in other embodiments any number of clients may be present.

It should be understood that FIG. 1 is intended to depict the representative major components of the computer system 100 and the client 132 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements embodying the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to:
(1) information permanently stored on a non-rewriteable storage medium, e.g., a read-only memory device attached to or within a computer system, such as a CD-ROM readable by a CD-ROM drive;
(2) alterable information stored on a rewriteable storage medium, e.g., a hard disk drive (e.g., DASD 125, 126, or 127) or diskette; or
(3) information conveyed to the computer system 100 by a communications medium, such as through a computer or a telephone network, e.g., the network 130, including wireless communications.

Such signal-bearing media, when carrying machine-readable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a flowchart of example processing for handling a request for a new connection by the I/O (Input/Output) manager 150, according to an embodiment of the invention. Control begins at block 200. Control then continues to block 205 where the I/O manager 150 receives a request for a new connection from the client 132 for a protocol. In various embodiments, the protocol may be HTTP (Hypertext Transport Protocol), JMS (Java Message Service), SMTP (Simple Mail Transfer Protocol), or any other appropriate protocol. The I/O manager 150 processes the requests for new connections on a protocol-by-protocol basis.

Control then continues to block 210 where the I/O manager 150 determines whether the number of concurrent connections for the protocol exceeds a high threshold. In various embodiments, each of the protocols may have the same high threshold, or some or all of the protocols may have different high thresholds. If the determination at block 210 is true, then the number of concurrent connections for the protocol exceeds the high threshold, so control continues to block 215 where the I/O manager 150 switches to non-blocking I/O for the protocol between the computer system 100 and the client 132 if non-blocking I/O is not already being used. Thus, the I/O manager 150 will transfer data on the connection using non-blocking I/O, meaning that concurrent connections for the protocol are processed by the same thread 144.

Control then continues to block 220 where the I/O manager 150 determines whether the number of concurrent connections is greater than the maximum number of connections for the protocol. In an embodiment, the maximum number of connections for the protocol is greater than the high threshold for the protocol. If the determination at block 220 is true, then the number of concurrent connections is greater than the maximum number of connections for the protocol, so control continues from block 220 to block 225 where the I/O manager 150 selects an active connection that has the minimum disruption for I/O operations between the computer system 100 and the clients 132, i.e., a connection that can be closed safely because it's at an appropriate point (called a window) in the protocol that allows it to be safely closed without interrupting I/O operations. Many protocols have such windows, such as HTTP and IIOP (Internet Inter-object Request Broker Protocol). Control then continues to block 230 where the I/O manager 150 closes the selected connection. Control then continues to block 299 where the logic of FIG. 2 returns.

If the determination at block 220 is false, then the number of concurrent connections is not greater than the maximum number of connections for the protocol, so control continues from block 220 to block 299 where the logic of FIG. 2 returns.

If the determination at block 210 is false, then the number of concurrent connections for the protocol does not exceed the high threshold for the protocol, so control continues from block 210 to block 299 where the logic of FIG. 2 returns.

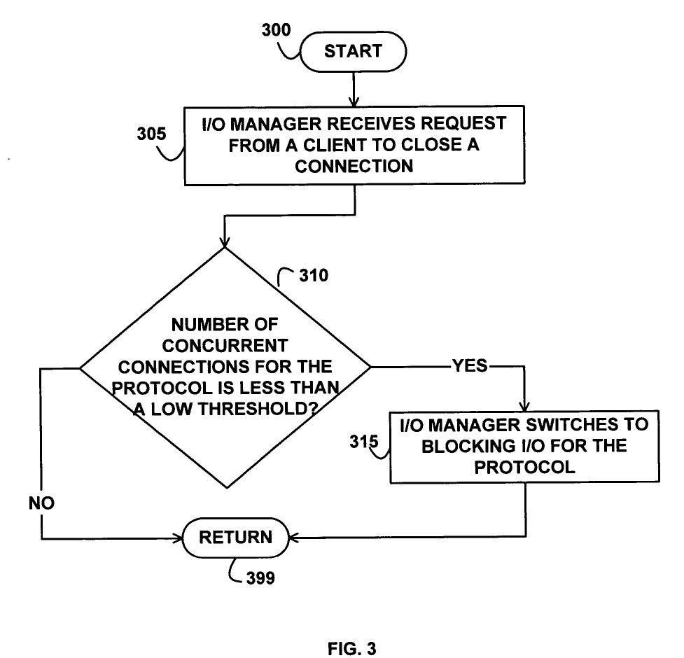

FIG. 3 depicts a flowchart of example processing for handling a request from the client 132 to close a connection by the I/O manager 150, according to an embodiment of the invention. Control begins at block 300. Control then continues to block 305 where the I/O manager 150 receives a request from the client 132 to close a connection.

Control then continues to block 310 where the I/O manager 150 determines whether the number of concurrent connections for the protocol is less than a low threshold. In an embodiment, the low threshold for the protocol is less than the high threshold for the protocol, and each protocol may have the same or a different low threshold. If the determination at block 310 is true, then the number of concurrent connections for the protocol is less than the low threshold, so control continues from block 310 to block 315 where the I/O manager 150 switches from non-blocking I/O to blocking I/O between the computer system 100 and the client 132 if the I/O manager 150 was previously using non-blocking I/O for the protocol. Blocking I/O means that concurrent connections for the protocol are processed by different of the threads 144. Control then continues to block 399 where the logic of FIG. 3 returns.

If the determination at block 310 is false, then the number of concurrent connections for the protocol is not less than the low threshold, so control continues from block 310 to block 399 where the logic of FIG. 3 returns.

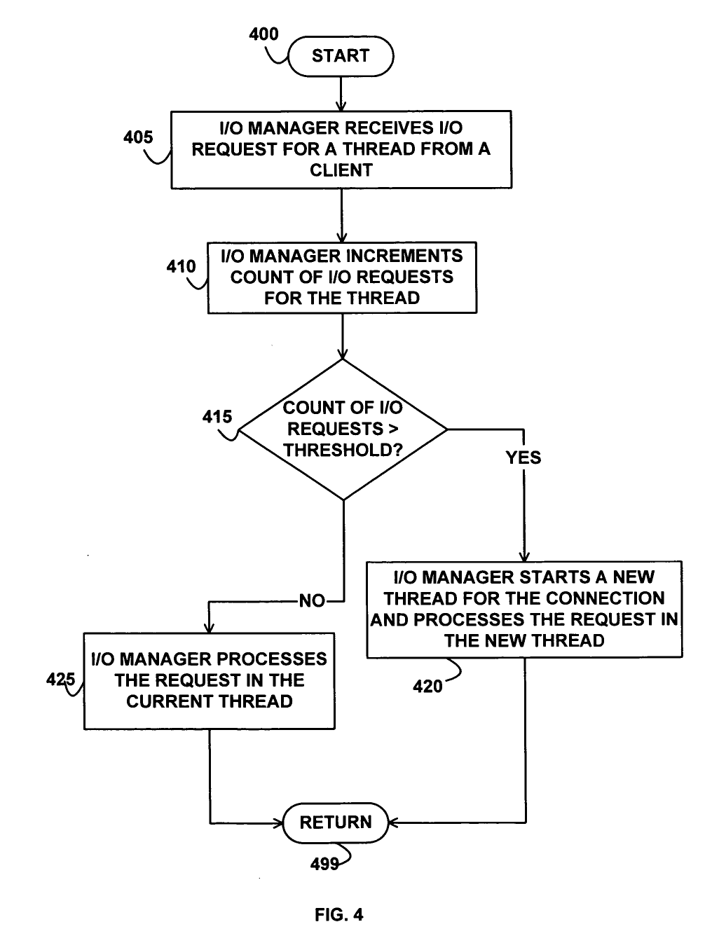

FIG. 4 depicts a flowchart of example processing for handling an I/O request by the I/O manager 150, according to an embodiment of the invention. Control begins at block 400. Control then continues to block 405 where the I/O manager 150 receives an I/O request for a thread from the client 132. Control then continues to block 410 where the I/O manager 150 increments a count of I/O requests for the thread. Control then continues to block 415 where the I/O manager 150 determines whether the count of I/O requests is greater than a threshold. If the determination at block 415 is true, then the count of I/O requests is greater than the threshold, so control continues to block 420 where the I/O manager 150 starts a new thread for the connection and processes the request using the new thread. Control then continues to block 499 where the logic of FIG. 4 returns.

If the determination at block 415 is false, then the count of the I/O requests is not greater than the threshold, so control continues from block 415 to block 425 where the I/O manager 150 processes the received request in the current thread. Control then continues to block 499 where the logic of FIG. 4 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of embodiments of the invention. But, embodiments of the invention may be practiced without these specific details. In other instances, well-known circuits, structures, and techniques have not been shown in detail in order not to obscure the invention.

1. A method comprising:
switching between blocking I/O and non-blocking I/O based on a number of concurrent connections.

2. The method of claim 1, wherein the switching between the blocking I/O and the non-blocking I/O further comprises:
switching from the blocking I/O to the non-blocking I/O if the number of concurrent connections is greater than a first threshold.

3. The method of claim 1, wherein the switching between the blocking I/O and the non-blocking I/O further comprises
switching from the non-blocking I/O to the blocking I/O if the number of concurrent connections is less than a second threshold.

4. The method of claim 1, further comprising.
closing one of the concurrent connections if the number of concurrent connections is greater than a maximum threshold.

5. The method of claim 4, further comprising:
selecting the one of the concurrent connections to close that has a minimum disruption to the I/O.

6. An apparatus comprising:
means for switching from blocking I/O to non-blocking I/O if a number of concurrent connections is greater than a first threshold; and
means for switching from the non-blocking I/O to the blocking I/O if the number of concurrent connections is less than a second threshold.

7. The apparatus of claim 6, wherein the first threshold is greater than the second threshold.

8. The apparatus of claim 6, further comprising:
means for closing one of the concurrent connections if the number of concurrent connections is greater than a maximum threshold.

9. The apparatus of claim 8, wherein the maximum threshold is greater than the first threshold.

10. The apparatus of claim 8, further comprising:
means for selecting the one of the concurrent connections to close that has a minimum disruption to the I/O.

11. A signal-bearing medium encoded with instructions, wherein the instructions when executed comprise:
switching from blocking I/O to non-blocking I/O if a number of concurrent connections is greater than a first threshold, wherein the blocking I/O comprises each of the concurrent connections has its own thread; and
switching from the non-blocking I/O to the blocking I/O if the number of concurrent connections is less than a second threshold.

12. The signal-bearing medium of claim 11, wherein the first threshold is greater than the second threshold.

13. The signal-bearing medium of claim 11, further comprising:
closing one of the concurrent connections if the number of concurrent connections is greater than a maximum threshold.

14. The signal-bearing medium of claim 13, wherein the maximum threshold is greater than the first threshold.

15. The signal-bearing medium of claim 13, further comprising:
selecting the one of the concurrent connections to close that has a minimum disruption to the I/O.

16. A computer system comprising:
a processor; and
memory encoded with instructions, wherein the instructions when executed on the processor comprise:
switching from blocking I/O to non-blocking I/O if a number of concurrent connections for a protocol is greater than a first threshold, wherein the blocking I/O comprises each of the concurrent connections has its own thread, and wherein the non-blocking I/O comprises all of the concurrent connections are processed by a same thread, and
switching from the non-blocking I/O to the blocking I/O if the number of concurrent connections is less than a second threshold.

17. The computer system of claim 16, wherein the first threshold is greater than the second threshold.

18. The computer system of claim 16, wherein the instructions further comprise:
closing one of the concurrent connections if the number of concurrent connections is greater than a maximum threshold.

19. The computer system of claim 18, wherein the maximum threshold is greater than the first threshold.

20. The computer system of claim 16, wherein the instructions further comprise:
selecting the one of the concurrent connections that has a minimum disruption of the I/O between the computer system and a client.
